(19) United States
(12) Patent Application Publication
(10) Pub. No.: US 2010/0089735 A1
(43) Pub. Date: Apr. 15, 2010

(54) HAPTIC KEYBOARD APPARATUS AND METHOD

(75) Inventors: TOSHISADA TAKEDA, Simi Valley, CA (US); Jamin Pandana, Oak Park, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Minebea Co., Ltd., Nagano (JP)

(21) Appl. No.: 12/425,339

(22) Filed: Apr. 16, 2009

Related U.S. Application Data
(60) Provisional application No. 61/045,938, filed on Apr. 17, 2008.

(51) Int. Cl. H01H 13/76

(52) U.S. Cl. 200/5 A

(57) ABSTRACT

A haptic keyboard apparatus includes a membrane resistor keyboard device and a haptic device. The membrane resistor keyboard device includes a plurality of key switches, each of the key switches being responsive to touch by a user. The haptic device is coupled to the membrane resistor keyboard device. The haptic device includes a plurality of haptic cells, each of which is disposed under a corresponding key switch. Each of the haptic cells is configured to provide haptic feedback in response to the touch by the user. In a specific embodiment, the haptic keyboard apparatus also includes a processor and a haptic controller that provide control signals to the haptic device. In an embodiment, the control signals include programmable voltages and frequencies, causing the haptic cells to effect vibrational patterns in response to the control signals and provide haptic feedback to the user.

### CROSS-REFERENCES TO RELATED APPLICATIONS

This application claims priority to U.S. Provisional Patent Application No. 61/045,938, filed Apr. 17, 2008, entitled “Haptic Keyboard Apparatus And Method,” by inventors Toshisada Takeda and Jamin Pandana, commonly assigned, incorporated in its entirety by reference herein for all purposes.

### BACKGROUND OF THE INVENTION

The present invention is directed to computing devices. More particularly, some embodiments of the invention provide keyboard apparatus and related methods that include haptic feedback to the user. Merely by way of example, the invention has been applied to a resistive membrane keyboard apparatus for a desk top computer, although it can also be applied to a laptop computer, modular computer, other computing devices such as personal digital assistants, as well as a remote control or a cell phone, etc.

Computing devices have proliferated. In the early days, large mainframe computers dominated the computing landscape. These large mainframe computers were developed by companies such as IBM Corporation of Armonk, N.Y. Mainframe computers have been replaced, at least in part, by smaller computing devices, commonly known as “PCs.” PCs come in various shapes and sizes. PCs are often run using computer software such as XPTM from Microsoft Corporation from Redmond Wash. Other types of computer software come from Apple Computer of Cupertino, Calif. Smaller PC versions are often called “lap top computers.” Other types of PCs include larger desktop versions. Still other versions of PCs can be found in smaller devices such as personal digital assistants, called PDAs, cellular phones, and a variety of other applications.

All of these computing devices generally require input devices for human users to interact with them. As merely an example, computer keyboards are most commonly used as such input devices for inputting characters, numerals and symbols to electronic devices, particularly to these computing devices such as the PCs.

Conventional keyboard devices tend to suffer from numerous limitations. For example, conventional keyboards often use mechanical switches for activating a key when it is depressed. The mechanical switches, however, can be bulky, expensive, and prone to mechanical failures. More recently, touch activated membrane switch have become common place in keyboard devices. The membrane switches tend to be more reliable and durable. On the other hand, membrane switches usually do not provide sufficient feedback to the user. These and other limitations of conventional keyboard devices are discussed further below.

From the above, it is seen that techniques for improving keyboard devices are highly desirable.

### BRIEF SUMMARY OF THE INVENTION

The present invention is directed to computing devices. More particularly, some embodiments of the invention provides keyboard apparatus and related methods that include haptic feedback to the user. Merely by way of example, the invention has been applied to a resistive membrane keyboard apparatus for a desk top computer, although it can also be applied to a laptop computer, modular computer, other computing devices such as personal digital assistants, as well as a remote control or a cell phone, etc.

More specifically, according to a specific embodiment, the invention provides a haptic keyboard apparatus. The haptic keyboard apparatus can be coupled to a host computer, a personal digital assistant, a cell phone, or a remote control device. In a specific embodiment, the haptic keyboard apparatus provides haptic feedback, such as a vibrational sensation, to a user entering information by pressing keys on the keyboard device. The haptic keyboard apparatus has a membrane resistor keyboard device that includes a plurality of key switches. Each the key switches is responsive to touch by a user. The haptic keyboard apparatus also has a haptic device coupled to the membrane resistor keyboard device. The haptic device includes a plurality of haptic cells, and each of the haptic cells is disposed under a corresponding key switch. Each of the haptic cells is configured to provide haptic feedback in response to the touch by the user.

In an embodiment of the haptic keyboard apparatus, the membrane resistor keyboard device includes a top membrane, a bottom membrane, and a spacer layer disposed between the top membrane and the bottom membrane. Each of the plurality of key switches includes a region in the membrane resistor keyboard device in which an electrical contact is formed when the top membrane is pressed against the bottom membrane.

In an embodiment, the haptic device includes a top membrane, a bottom membrane, and a piezoelectric layer disposed between the top membrane and the bottom membrane. Each of the plurality of haptic cells includes a region in the haptic device in which a voltage applied between the top membrane and the bottom membrane causes deformation in the piezoelectric layer in the region. In a specific embodiment, the piezoelectric layer can be formed as a layer of piezoelectric ink material overlying the bottom membrane of the haptic device.

Depending on the embodiment, the haptic keyboard apparatus can have key caps like those in a computer keyboard. Alternatively, the haptic keyboard apparatus can have touch pads. Either the key caps or the touch pads are disposed over the corresponding key switches. In some embodiments, the plurality of key switches are arranged in a matrix form. In a specific embodiment, the keyboard has at least twenty-six key switches. In some embodiments, there can be as many as at least 104 to 109 key switches, or more.

In an embodiment, the haptic keyboard apparatus includes a processor electrically coupled to the membrane resistor keyboard device and the haptic device. The process receives a signal from the membrane resistor keyboard for identifying the key switch being touched and outputting a control signal in response to the touch by the user.

The haptic keyboard apparatus also includes a controller electrically coupled to the processor and the haptic device. The controller being is also coupled to a plurality of reference voltage sources. The controller is configured to output a control signal to the haptic cell associated with the identified key switch. The control signal is characterized by a predetermined voltage and a predetermined frequency, causing vibration in the piezoelectric material in the haptic cell. In a specific embodiment, the actuator control signal is characterized by a programmable voltage and a programmable frequency. The programmable voltage and the programmable frequency can be selected by a user for each of the key switches.

According to another embodiment, the present invention provides a haptic keyboard apparatus that has a membrane resistor keyboard device, which includes a top layer, a bottom layer, and a spacer layer disposed between the top layer and the bottom layer. The haptic keyboard apparatus also has a plurality of key switches overlying the top layer of the membrane resistor keyboard device. In an embodiment, there are at least twenty-six key switches, each of which being responsive to touch by a user. In a specific embodiment, there are at least 104 to 109 key switches, each of which being responsive to touch by a user.

In an embodiment, a plurality of actuators are coupled to the bottom layer of the membrane keyboard device. Each of the actuators is disposed under a corresponding key switch, and each of the actuators is configured to output a vibrational force to provide haptic feedback in response to the touch by the user.

In the above haptic keyboard apparatus, a processor is electrically coupled to the membrane resistor keyboard device for identifying the key switch being touched and outputting a control signal in response to the touch by the user. A controller is electrically coupled to the processor and the haptic device, and further coupled to a plurality of reference voltage sources. The controller is configured to output an actuator control signal to the actuator associated with the identified key switch. The actuator control signal has a predetermined voltage and a predetermined frequency, and causes vibration in the identified key switch.

In an embodiment, the actuator control signal has a programmable voltage and a programmable frequency. The programmable voltage and the programmable frequency are selected by a user for each of the key switches.

In an embodiment, the membrane resistor keyboard device includes a top membrane, a bottom membrane, and a spacer layer disposed between the top membrane and the bottom membrane. An electrical contact is formed when the top membrane is pressed against the bottom membrane by the touch from a user. In a specific embodiment, the processor is configured for scanning the membrane resistor keyboard device and sending scan-codes to a second processor.

Many benefits are achieved by way of this invention, and one or more benefits can be achieved in one or more of the embodiments. As an example, the present invention provides a haptic keyboard apparatus using a cost-effective membrane key switch design. Depending on the embodiment, the haptic keyboard can have one or more of the following features: thinner, less prone to mechanical failure, and capable of providing quicker feedback to touch, compared with conventional keyboard devices. In some embodiments, the haptic keyboard apparatus is quiet and can provide more of a touch screen feel but also provides a tactile feedback. In some embodiments, techniques are provided for programmable haptic feedbacks that can be tailored by the user. Some embodiments of the method and apparatus are also more efficient than conventional techniques. These and other benefits will be described in more detail throughout the present specification and more particularly below.

Various additional features and advantages of the present invention can be more fully appreciated with reference to the detailed description and accompanying drawings that follow.

### BRIEF SUMMARY OF THE DRAWINGS

FIG. 1A is a simplified diagram illustrating a haptic keyboard apparatus according to an embodiment of the present invention;

FIG. 1B is a simplified diagram illustrating a haptic keyboard apparatus according to a specific embodiment of the present invention; and

FIG. 2 is a simplified block diagram illustrating a haptic keyboard apparatus according to an embodiment of the present invention.

### DETAILED DESCRIPTION OF THE INVENTION

The present invention is directed to computing devices. More particularly, embodiments of the invention provides keyboard apparatus and related methods that include haptic feedback to the user. Merely by way of example, the invention has been applied to a resistive membrane keyboard apparatus for a desk top computer, although it can also be applied to a laptop computer, modular computer, other computing devices such as personal digital assistants, as well as a remote control or cell phone, etc.

Depending upon the embodiment, the present invention includes one or more of various features, which may be used. These features include the following:
1. A membrane resistor Key Matrix assembly (including three layers, namely, top, spacer, bottom) is used, and the key switch cell is laid on the top layer.
2. A touch feel feedback actuator Haptic Matrix assembly is placed at its bottom layer, including actuators in one to one correspondent to the resistor key switches in the Key Matrix.
3. A keyboard MCU for scanning the Key Matrix and sending the scan-codes to PC. This MCU also is configured to send a signal to the Touch Feel Feedback Controller regarding which key or keys is/are being pressed and released.
4. The Touch Feel Feedback Controller is configured to multiplex or switch the correct voltages and frequency signals to a specific cell or cells in the Haptic Matrix to stimulate the touch feel actuator to have a vibrate feel on the said key switch/switches is/are pressed.
5. The vibrating feels are depended on the frequencies and voltages that are applied to the vibrating materials. The voltages and frequencies can be programmed from Keyboard MCU to Haptic MUX (multiplexer)/Switching Controller

As shown, the above features may be in one or more of the embodiments to follow. These features are merely examples, which should not unduly limit the scope of the claims herein. One of ordinary skill in the art would recognize many variations, modifications, and alternatives.

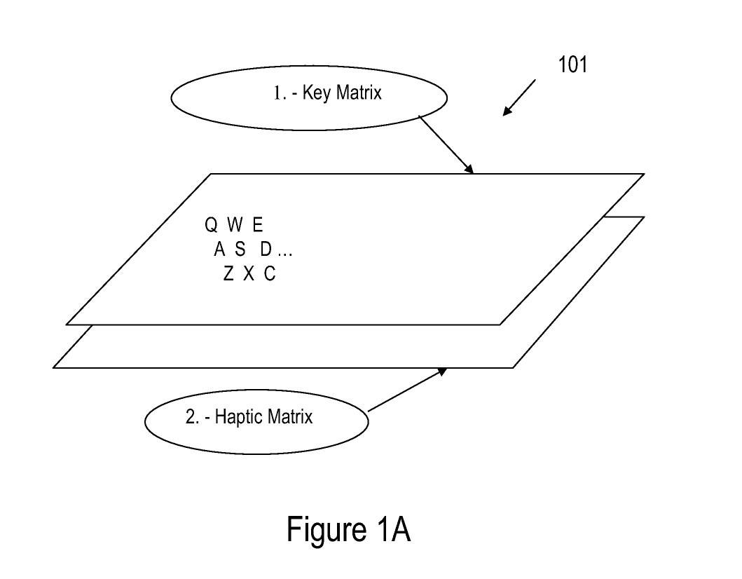

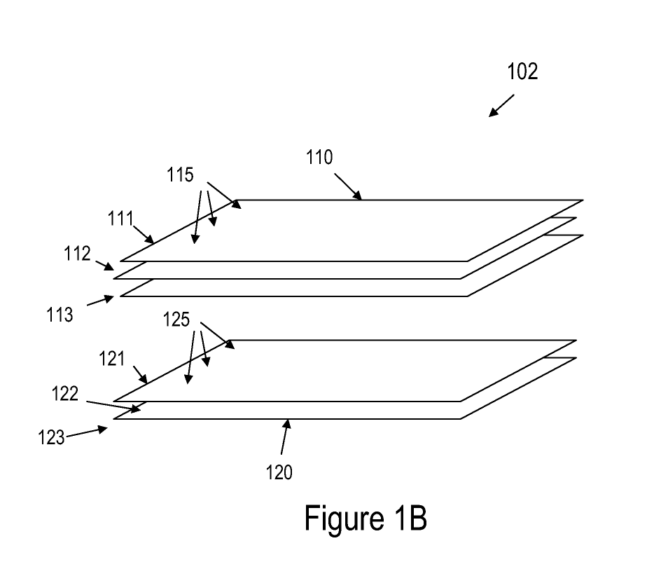

FIG. 1A is a simplified diagram illustrating a haptic keyboard apparatus according to an embodiment of the present invention. This diagram is merely an example, which should not unduly limit the scope of the claims herein. One of ordinary skill in the art would recognize other variations, modifications, and alternatives. As shown, haptic keyboard apparatus 101 includes a membrane resistor keyboard device, which has a plurality of key switches. Each of the key switches is responsive to touch by a user. In an embodiment, the plurality of key switches are arranged in a matrix form on the top layer, shown as “1. Key Matrix” in FIG. 1A. The haptic keyboard apparatus 101 also includes a haptic device coupled to the membrane resistor keyboard device. The haptic device includes a plurality of haptic cells, and each of the haptic cells is disposed under a corresponding key switch. In a specific embodiment, the haptic cells are arranged in a matrix form, shown as “2. Haptic Matrix” in FIG. 1A. Each of the haptic cells is configured to provide haptic feedback in response to the touch by the user.

FIG. 1B is a simplified diagram illustrating a haptic keyboard apparatus according to a specific embodiment of the present invention. This diagram is merely an example, which should not unduly limit the scope of the claims herein. One of ordinary skill in the art would recognize other variations, modifications, and alternatives. As shown, in haptic keyboard apparatus 102, the membrane resistor keyboard device 110 includes a top membrane 111, a bottom membrane 113, and a spacer layer 112 disposed between the top membrane and the bottom membrane. Each of the plurality of key switches, e.g., shown as 115, includes a region in the membrane resistor keyboard device in which an electrical contact is formed when the top membrane is pressed against the bottom membrane.

In haptic keyboard apparatus 102, the haptic device 120 includes a top membrane 121, a bottom membrane 123, and a piezoelectric layer 122 disposed between the top membrane and the bottom membrane. Each of the plurality of haptic cells, e.g., 125, includes a region in the haptic device in which a voltage applied between the top membrane and the bottom membrane causes deformation in the piezoelectric layer in the region. In a specific embodiment, as shown in FIG. 1B, the piezoelectric layer can be formed as a layer of piezoelectric ink material overlying the bottom membrane of the haptic device.

Depending on the embodiment, the haptic keyboard apparatus can have key caps like those used in a computer keyboard. Alternatively, the haptic keyboard apparatus can have touch pads. Either the key caps or the touch pads are disposed over the corresponding key switches. In some embodiments, the plurality of key switches are arranged in a matrix form. In a specific embodiment, there are at least twenty-six key switches, each of the key switches being responsive to touch by a user. For example, the twenty-six or more key switches can include the alphabetic keys in a qwerty keyboard. In another example, the keyboard device can include the alphanumeric and control keys in a qwerty keyboard. In other embodiments, the keyboard device can include keys used in other computing devices such as personal digital assistants, as well as a remote control or cell phone, etc. In some embodiments, there can be as many as at least 104 to 109 key switches, or more. Of course, there can be other variations, modifications, and alternatives.

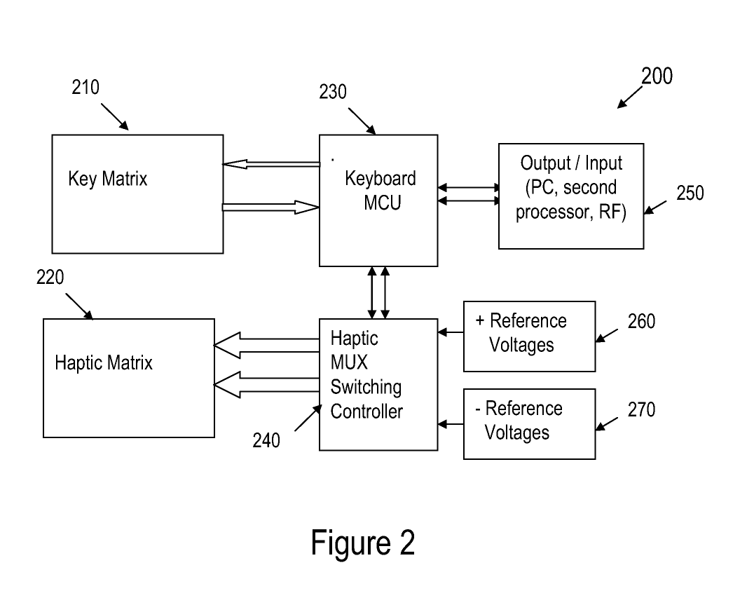

FIG. 2 is a simplified block diagram for haptic keyboard apparatus 200 according to an embodiment of the present invention. This diagram is merely an example, which should not unduly limit the scope of the claims herein. One of ordinary skill in the art would recognize other variations, modifications, and alternatives. As shown in FIG. 2, haptic keyboard apparatus 200 includes a membrane resistor keyboard device 210 (labeled as Key Matrix), a haptic device 220 (labeled as Haptic Matrix), a processor 230, and a controller 240. In certain embodiments, haptic keyboard apparatus 200 may also have additional support circuits 250, which can include circuits for output/input, one or more additional processors, and RF circuits, etc. In some embodiments, membrane resistor keyboard device 210 and haptic device 220 can be similar to the counter part devices in FIGS. 1A and 1B. In a specific embodiment, the key switches and haptic cells are arranged in matrix form. Of course, there can be many variations, modifications, and alternatives.

In FIG. 2, processor 230 is electrically coupled to the membrane resistor keyboard device 210 for receiving a signal in response to a user pressing a particular key. The processor identifies the key switch being touched and also outputs a control signal in response to the touch by the user. In an embodiment, the processor is configured for scanning the membrane resistor keyboard device and sending scan-codes to a second processor. The second processor, for example, can be the main processor in a personal computer, or internal USB downstream hub.

In an embodiment, haptic controller 240 is electrically coupled to processor 230 and to haptic device 220. The controller is further coupled to a plurality of reference voltage sources such as positive reference voltages 260 and negative reference voltages 270 in FIG. 2. The controller is configured to output a control signal to the haptic cell associated with the identified key switch. In some embodiments, the control signal is an actuator control signal. In an embodiment, the control signal has a predetermined voltage and a predetermined frequency. The control signal causes vibration in the piezoelectric layer in the haptic cell. The actuator control signals can cause different vibration patterns in the actuator depending on the voltage and frequency of the control signal. In an embodiment, the actuator control signal can have a programmable voltage and a programmable frequency. That is, a user can select a voltage and a frequency to be associated with each of the key switches. In an embodiment, this programming capability can be provided in processor 230 in FIG. 2. Alternatively, the keyboard device is coupled to a main processor. Then the programming of the control signals can be provided by the main processor.

While the preferred embodiments of the invention have been illustrated and described, it will be clear that the invention is not limited to these embodiments only. Numerous modifications, changes, variations, substitutions, and equivalents will be apparent to those skilled in the art without departing from the spirit and scope of the invention as described in the claims.

What is claimed is:

1. A haptic keyboard apparatus comprising:
a membrane resistor keyboard device, including a top layer, a bottom layer, and a spacer layer disposed between the top layer and the bottom layer;
a plurality of key switches including at least twenty-six key switches, each of the key switches including a region in the membrane resistor keyboard device, each of the key switches being responsive to touch by a user;
a haptic device underlying the membrane keyboard device, the haptic device including a top layer, a bottom layer, and a layer of piezoelectric material disposed between the top layer and the bottom layer;
a plurality of haptic cells, each of the haptic cells including a region in the haptic device, each of the haptic cells being disposed under a corresponding key switch and configured to simulate a touch feel in the corresponding key switch in response to the touch by the user;
a processor electrically coupled to the membrane resistor keyboard device and the haptic device for identifying the key switch being touched and outputting a control signal in response to the touch by the user; and
a controller electrically coupled to the processor and the haptic device, the controller being further coupled to a plurality of reference voltage sources, the controller being configured to output a control signal to the haptic cell associated with the identified key switch, the control signal being characterized by a predetermined voltage and a predetermined frequency.

2. The haptic keyboard apparatus of claim 1 further comprising a plurality of touch pads overlying the top layer of the membrane keyboard device.

3. The haptic keyboard apparatus of claim 1 further comprising a plurality of key caps overlying the top layer of the membrane keyboard device.

4. The haptic keyboard apparatus of claim 1 wherein the control signal is characterized by a programmable voltage and a programmable frequency.

5. The haptic keyboard apparatus of claim 4 wherein the programmable voltage and the programmable frequency are selected by a user for each of the key switches.

6. The haptic keyboard apparatus of claim 1 wherein the membrane resistor keyboard device comprises:
a top membrane;
a bottom membrane;
a spacer layer disposed between the top membrane and the bottom membrane, whereby an electrical contact is formed when the top membrane is pressed against the bottom membrane.

7. The haptic keyboard apparatus of claim 1 wherein the haptic device comprises:
a top membrane;
a bottom membrane; and
a piezoelectric layer disposed between the top membrane and the bottom membrane, wherein a voltage applied between the top membrane and the bottom membrane causes deformation in the piezoelectric layer.

8. The haptic keyboard apparatus of claim 1 wherein the processor is configured for scanning the membrane resistor keyboard device and sending scan-codes to a second processor.

9. A haptic keyboard apparatus comprising:
a membrane resistor keyboard device, including a plurality of key switches, each of the key switches being responsive to touch by a user; and
a haptic device coupled to the membrane resistor keyboard device, the haptic device including a plurality of haptic cells, each of the haptic cells disposed under a corresponding key switch, each of the haptic cells being configured to provide haptic feedback in response to the touch by the user.

10. The haptic keyboard apparatus of claim 9 wherein the membrane resistor keyboard device comprises:
a top membrane;
a bottom membrane; and
a spacer layer disposed between the top membrane and the bottom membrane, wherein each of the plurality of key switches includes a region in the membrane resistor keyboard device in which an electrical contact is formed when the top membrane is pressed against the bottom membrane.

11. The haptic keyboard apparatus of claim 9 wherein each of the haptic cells in the haptic device is configured to simulate a touch feel in response to a control signal.

12. The haptic keyboard apparatus of claim 9 wherein the haptic device comprises:
a top membrane;
a bottom membrane; and
a piezoelectric layer disposed between the top membrane and the bottom membrane, wherein each of the plurality of haptic cells includes a region in the haptic device in which a voltage applied between the top membrane and the bottom membrane causes deformation in the piezoelectric layer in the region.

13. The haptic keyboard apparatus of claim 12 wherein the piezoelectric layer comprises a layer of piezoelectric ink material overlying the bottom membrane of the haptic device.

14. The haptic keyboard apparatus of claim 9 wherein the plurality of key switches are arranged in a matrix form.

15. The haptic keyboard apparatus of claim 9 further comprising a plurality of touch pads overlying corresponding key switches of the membrane keyboard device.

16. The haptic keyboard apparatus of claim 10 further comprising a plurality of key caps overlying corresponding key switches of the membrane keyboard device.

17. The haptic keyboard apparatus of claim 9 further comprising a processor electrically coupled to the membrane resistor keyboard device and the haptic device for identifying the key switch being touched and outputting a control signal in response to the touch by the user.

18. The haptic keyboard apparatus of claim 17 further comprising a controller electrically coupled to the processor and the haptic device, the controller being further coupled to a plurality of reference voltage sources, the controller being configured to output a control signal to the haptic cell associated with the identified key switch, the control signal being characterized by a predetermined voltage and a predetermined frequency for causing vibration in the piezoelectric layer in the haptic cell.

19. The haptic keyboard apparatus of claim 18 wherein the actuator control signal is characterized by a programmable voltage and a programmable frequency.

20. The haptic keyboard apparatus of claim 19 wherein the programmable voltage and the programmable frequency are selected by a user for each of the key switches.
